(19) United States
(12) Patent Application Publication
(10) Pub. No.: US 2007/0193232 A1
(43) Pub. Date: Aug. 23, 2007

(54) Procedure to regenerate an exhaust gas purification system and a device to perform such a procedure

(75) Inventors: Ralf Wirth, Farmington Hills (DE); Marcel Wuest, Korntal (DE); Michael Kolitsch, Weissach (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 11/703,368

(22) Filed: Feb. 7, 2007

(30) Foreign Application Priority Data
Feb. 21, 2006 (DE) 10 2006 007 984.1

(51) Int. Cl. B01D 46/00

(52) U.S. Cl. 55/283

(57) ABSTRACT

Proposed are a procedure to regenerate an exhaust gas purification system, which is set up in an exhaust area of a combustion engine, which is installed as a driving motor in a vehicle, and a device to perform the procedure. The exhaust gas purification system is regenerated of at least one stored exhaust component during the regeneration. A reserve-tank-level, warning when reached, is increased depending on a regeneration-demand of the exhaust gas purification system. With the procedure according to the invention it can be secured, that a vehicle cannot break down with an empty tank because of regeneration. Furthermore it can be secured, that the regeneration can be performed completely within the remaining range of the vehicle.

The invention is based on a procedure to regenerate exhaust gas purification system and on a device to perform such a procedure, as a kind of independent claim.

In DE 199 06 287 A1 a procedure to operate a particle filter of a combustion engine, which is regenerated in regular intervals, is described. The regeneration is subject to the size of the load condition of the particle filters. Without conditioning the particles, the particles oxidize from a temperature of about 550° C. on. When reaching the ignition temperature, an exothermal reaction is set in motion, causing the particles to burn up.

In DE 197 39 848 A1 different operation procedures of a combustion engine are described, where a NOx-storage catalyst is set up in the exhaust area. Because of the finite storage capacity of the NOx-storage catalyst, the regeneration of the NOx-storage catalyst must be designed in between by offering hydrocarbon and/or carbon monoxide, which could be made available within the motor, for example. Unwanted sulfur storage in the NOx-storage catalyst can be removed by operating the NOx-storage catalyst with high temperatures with a rich exhaust. Such a procedure is, for example, described in DE 198 43 859 A1.

To reach the necessary operating temperature of the exhaust gas purification system to perform the regeneration, the exhaust temperature can, for example, be increased or the exhaust gas purification system can be heated directly. To reach the increase of the exhaust temperature, the effectiveness of the combustion engine can, for example, be deteriorated. Another possibility is to bring flammable exhaust components into the exhaust area of the combustion engine, which reacts exothermally on a catalytic efficient surface. The catalytic efficient surface can, for example, be contained in the particle filter. In a catalyst, for example a (NOx)-storage catalyst, the catalyst efficient surface exists in principle anyway.

To increase the operating temperature of the exhaust gas purification system compared with the current operating temperature energy is necessary, which is generally gained from the fuel, which is also provided for the combustion engine.

Generally known as state of the art is the equipment for vehicles with a tank-level-information, which provides a warning signal if the level in the tank falls either below a reserve level or below a specified value, which is calculated based on the average consumption for the remaining range of the vehicle.

According to the invention, the procedure to regenerate exhaust gas purification system has the advantage, that the break down of a vehicle with an empty tank, because of a regeneration of the exhaust gas purification system, can be avoided.

Another fundamental advantage is that an occurring regeneration does not have to be interrupted. By that, the regeneration can be performed in an energy efficient manner.

Advantageous further developments and forms of the procedure according to the invention result from depending claims.

One form is so designed, that the increase of the reserve-tank-level is conducted, if during the driving route, which is achievable with the current tank level, an expected regeneration-demand occurs. By considering a regeneration-demand when determining a reserve-tank-level, providing a warning signal when reached, it can therefore be assumed, that the regeneration can be performed within the remaining range of the vehicle.

One form is so designed, that the increase of the reserve-tank-level can only be conducted if regeneration cannot be fully performed with the available tank level at the time of the regeneration-demand. Thus, an unnecessary change of the reserve-tank-level can be avoided on the one hand, on the other hand it can be ensured, that the regeneration can be completed before the fuel tank is empty.

One form is so designed, that the next regeneration-demand is calculated based on the fuel consumption since the last regeneration. An additional or alternative form is so designed, that the next regeneration-demand is calculated depending on at least one working condition of the combustion engine and/or at least by a parameter of the exhaust. A further additional or alternative form is so designed, that the next regeneration-demand is calculated depending on the loading condition of the particle filter. With at least one of these measurements an exact adjustment to the expected occurrence of a regeneration-demand is achieved, compared with the specification of a fixed value, for example a km-value.

One form is so designed, that the reserve-tank-level is increased by an amount, which is necessary to perform the regeneration.

The device, according to the invention, provides a specifically set up control device to perform the procedure. The procedure is saved as an automatic sequence on a memory of the control device.

The computer program, according to the invention, provides, that all steps of the procedure according to the invention can be performed, when it is running on a computer.

The computer program product, according to the invention, with a program code, which is saved on a machine-readable carrier, executes the procedure according to the invention, when the program is executed on a computer or in a control device.

Further advantageous developments and forms of the procedure according to the invention follow from further depending claims and from the following description.

### DRAWING

FIG. 1 shows a technical environment in which a process according to the invention is executed.

FIG. 1 shows a combustion engine 10 with an air sensor 12 set up in its intake area 11 and exhaust gas purification system 14 set up in its exhaust area 13. A loading-condition-sensor 15 is allocated to the exhaust gas purification system 14.

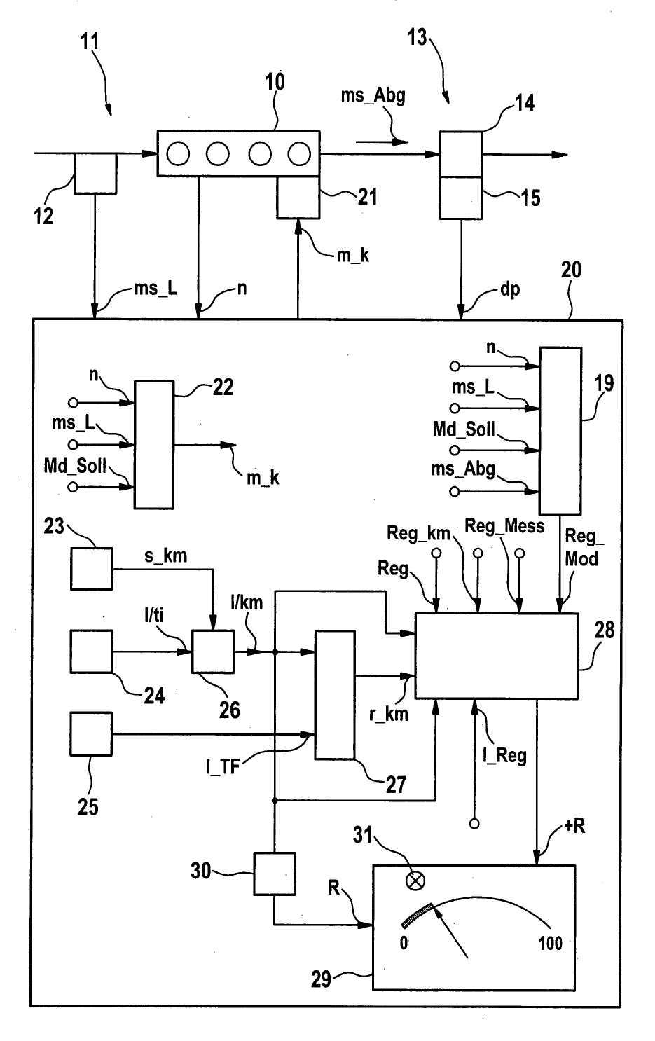

The air sensor 12 provides the control device 20 with an air signal ms_L, the combustion engine 10 provides a rotational speed signal n and the loading-condition-sensor provides a loading-condition-measure-signal dp.

In the exhaust area 13 an exhaust gas stream ms_Abg occurs.

The control device 20 provides a fuel signal m_K with a fuel-delivery-control-device 21.

The control device 20 contains a fuel-signal-determination 22, for which the rotational speed signal n, the air signal ms_L and a turning-moment-nominal-value Md_Soll are provided, and which provides the fuel signal m_K.

Furthermore, the control device 20 contains a driving route-determination 23, which provides a driving route s_km. Furthermore, a flow-determination 24 is designed, providing a time-oriented fuel consumption 1/ti. Further a tank-level-determination 25 is designed, providing a tank level 1_TF.

A fuel consumption-determination 26 determines a fuel consumption 1/km related to the way. A range-determination 27 determines the expected achievable range r_km based on the current tank level.

The range r_km, the fuel consumption 1/km related to the way, a regeneration signal Reg, a regeneration-demand Reg_km related to the way, a measure signal related to the regeneration-demand Reg_Mess, a calculated regeneration-demand Reg_Mod and a regeneration-consumption 1_Reg are provided for a reserve-level-change-determination 28.

The calculated regeneration-demand Reg_Mod is provided by a loading-condition-model 19, for which the rotational speed signal n, the air signal ms_L, the turning-moment-nominal-value Md_Soll and the fuel gas stream ms_Abg are provided.

The reserve-level-change-determination 28 provides a tank level indicator 29 with an increase +R of a reserve-tank-level R. The reserve-tank-level R is provided by a reserve-tank-level-specification 30 and is made available to the tank level indicator 29. The tank level indicator contains a warning facility 31.

According to the invention it has to be proceeded in the following way:

The combustion engine 10 is installed as driving motor into a not shown vehicle. The fuel-signal-determination 22 determines the fuel signal m_K, which is provided for the fuel-delivery-control-device 21, depending on, for example, the rotational speed signal n and/or the air signal ms_L and/or the turning-moment-nominal-value Md_Soll. The turning-moment-nominal-value Md_Soll corresponds, for example, with a position of a not shown accelerator pedal of the vehicle. The turning-moment-nominal-value Md_Soll reflects already on its own a charge status of the combustion engine 10.

At least one unwanted component in the fuel gas stream ms_Abg is stored in the exhaust gas purification system 14. The exhaust gas purification system 14 is, for example, realized as storage catalyst, particularly as NOx-storage catalyst. The exhaust gas purification system 14 contains additionally or alternatively a particle filter. In the following it is assumed, that the exhaust gas purification system 14 is realized as a particle filter. The particles, which are contained during the operation of the combustion engine 10 in the fuel gas stream ms_Abg, are stored in the particle filter 14. The particle filter 14 is freed from the stored particles when reaching a specified loading condition. The regeneration occurs in cyclical intervals. In the easiest case it can be specified, that a regeneration has to be conducted after a driving route of, for example, 500 kilometers.

The regeneration-demand Reg_km related to the way corresponds with such a signal. The regeneration-demand Reg_km related to the way, the measure signal related to the regeneration-demand Reg_Mess, and the calculated regeneration-demand Reg_Mod indicate in each case, when a regeneration-demand arises. The demand can, for example, be related to the time or the fuel volume. In general, the demand is related to a driving route. With the regeneration signal Reg, which signals a regeneration process, it can be referred to Reg_km, Reg_Mess, Reg_Mod to reset at least one regeneration-demand.

The measure signal related to the regeneration-demand Reg_Mess can alternatively or additionally be designed beside the regeneration-demand Reg_km related to the way, which only states—without considering further sizes—, that after a specified driving route of, for example, 500 kilometers a regeneration is necessary. The measure signal related to the regeneration-demand Reg_Mess can be derived from the loading-condition-measure-signal dp, which reflects the loading condition of the particle filter 14. The loading-condition-sensor 15 compasses, for example, the differential pressure, which occurs on the particle filter 14.

Furthermore, the calculated regeneration-demand Reg_Mod can be designed additionally or alternatively, providing a loading-condition-model 19. The loading-condition-model 19 can determine the loading condition subject to the load of the combustion engine 10. A size for the load reflects, for example, the turning-moment-nominal-value Md_Soll. Additionally or alternatively, the air signal ms_L and/or the rotational speed signal n and/or the fuel gas stream ms_Abg can be taken into account. The first 3 named values are operation values of the combustion engine 10, while the fuel gas stream ms_Abg is an example for a parameter of the exhaust.

Because more than one size for the loading condition of the particle filter 14 is provided for the control device 20, single sizes can be performed with plausibility for the loading condition.

On the basis of the driving route s_km, provided by the driving route-determination 23, and of the time-oriented fuel consumption 1/ti, provided by the flow-determination 24, the fuel consumption-determination 26 determines the fuel consumption 1/km related to the way. The range-determination 27 determines—based on the fuel consumption 1/km related to the way and the tank level 1_TF, provided by the tank level-determination 25|[s1], the remaining range r_km, which particularly is provided as route in kilometers.

The vehicle includes the tank level indicator 29, where the number zero is entered as measure for an empty tank and the number 100 as measure for a full tank. A reserve-tank-level R is designed, by which a warning signal 31, for example a light, is activated when reaching the level. The reserve-tank-level R is preferably a fixed specified fuel rest volume. The reserve-tank-level-determination 30 can, for example, influence the reserve-tank-level R depending on the fuel consumption 1/km related to the way, lowering the reserve-tank-level R, if there is a tendency to consume little.

According to the invention it is designed, that the reserve-tank-level R depends on a regeneration-demand Reg_km, Reg_Mess, Reg_Mod. According to a simple form it is possible to arrange, that—independent from the range r_km within the regeneration-demand Reg_km, Reg_Mess, Reg_Mod, signaling a necessary regeneration during the range r_km, the increase +R of the reserve-tank-level R is designed. The check happens within the reserve-level-change-determination 28 by comparing the route, which is given by the regeneration-demand Reg_km, Reg_Mess, Reg_Mod, with the remaining range r_km. As soon as the range r_km is higher than the route till the next regeneration, the increase +R is provided.

According to an advantageous form, the increase +R is only conducted if regeneration cannot be completely performed with the tank level being available for the regeneration-demand Reg_km, Reg_Mess, Reg_Mod. For performing this task the reserve-level-change-determination 28 does not only need the route till the expected next regeneration, which is provided of at least one of the regeneration-demands Reg_km, Reg_Mess, Reg_Mod, but also the fuel consumption for a regeneration, which the regeneration-consumption 1_Reg states.

Preferably, the fuel consumption 1/km of the vehicle related to the way is further considered in the reserve-level-change-determination 28. Alternatively it can be calculated with a constant value. The increase +R of the reserve-tank-level R only occurs, if the regeneration cannot be completely performed within the range r_km.

With that procedure according to the invention, an increase +R of the reserve-tank-level R occurs if necessary, according to an earlier activation of the warning facility 31. With that, the driver of the vehicle has the chance to fill up in time before a required regeneration, if necessary. With that it can be secured, that the vehicle does not break down with an empty tank because of regeneration. Furthermore it can be secured, that the regeneration can be completely finished and that no interruption, which would be connected with a considerable increased expenditure of energy, is needed.

1. A method of regenerating an exhaust gas purification system in an exhaust area of a combustion engine, which is regenerated by at least one stored exhaust component during the regeneration process, the method comprising increasing a reserve-tank-level, which indicates a warning when reached, depending on a regeneration-demand of the exhaust gas purification system.

2. A method according to claim 1, wherein increasing includes increasing the reserve tank level only if a regeneration is necessary during the driving route, and is achievable with the current tank level.

3. A method according to claim 2, wherein increasing includes increasing the reserve-tank-level only if a regeneration within the remaining range cannot be completely performed.

4. A method according to claims 2, wherein the regeneration-demand is related to a fixed specified route.

5. A method according to claim 2, wherein the regeneration-demand is related to a measure signal, with which a loading-condition-measure-signal, which is provided by a loading-condition-sensor, is taken into account.

6. A method according to claim 2, wherein the regeneration-demand is calculated, with at least an operation value of the combustion engine and/or at least a parameter of an exhaust taken into account.

7. A method according to claim 1, wherein increasing includes increasing the reserve-tank-level by an amount, which is necessary to perform the regeneration.

8. A device to regenerate an exhaust gas purification system, comprising a control device that increases a reserve-tank-level, which indicates a warning when reached, depending on a regeneration-demand of the exhaust gas purification system.

9. A computer program that regenerates an exhaust gas purification system in an exhaust area of a combustion engine which is regenerated by at least one stored exhaust component during the regeneration process, the computer program increasing a reserve-tank-level, which indicates a warning when reached, depending on a regeneration-demand of the exhaust gas purification system.

10. A computer program product with a program code that is saved on a machine-readable carrier, that, when executed, regenerates an exhaust gas purification system in an exhaust area of a combustion engine which is regenerated by at least one stored exhaust component during the regeneration process, the executed computer program product increasing a reserve-tank-level, which indicates a warning when reached, depending on a regeneration-demand of the exhaust gas purification system.
